(19) United States
(12) Patent Application Publication
(10) Pub. No.: US 2003/0132362 A1
(43) Pub. Date: Jul. 17, 2003

(54) Tree supporting device

(76) Inventor: Neil R. Miller, Charlotte, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/047,336

(22) Filed: Jan. 14, 2002

(51) Int. Cl. F16M 13/00

(52) U.S. Cl. 248/530

(57) ABSTRACT

A support device for supporting, stabilizing and fertilizing young, damaged or newly planted trees and/or other plant life includes a cross member having opposing first and second ends with a first stake member attached intermediate said ends and a second stake member attached intermediate the first stake member and the second end. Located at the first end of the cross member is an optional, additional support notch. The stake members having a hollow, tubular configuration with an open inlet at their respective upper ends and an insertion point at their respective lower ends. The first stake member further comprising a plurality of apertures extending vertically along the length of the member and having an overall length greater than that of the second stake member. An installation aid is provided which matingly engages the stake members is used to uniformly embed the device into the ground.

### FIELD OF THE INVENTION

The present invention relates to multi-functional devices for supporting and stabilizing young, damaged or newly planted trees and other plant life against high winds and other forces of nature. More particularly, the present invention relates to a multi-functional device which supports and stabilizes trees and other plant-life above the ground and helps fertilize root systems of the trees and plant life under ground level.

### BACKGROUND OF THE INVENTION

Young plants and trees often require support and stabilization until they reach a level of maturity where the root system of the tree trunk or plant stem is able to support itself in the ground. Further, damaged trees and plants often require support and stabilization while they are healing. Still further, trees and plants requiring support often require assistance in growth development. Various types of support systems have been designed to satisfy the above requirements. However, all of these support systems have proven to be insufficient, as they do not satisfy all of the above requirements. Rather, known systems typically meet only one of the requirements.

It is known in the art to use supporting devices for trees and plant life such as hangers, trellises, retaining wires and stakes, etc. These types of devices typically have a single stake or post embedded in the ground a small distance from the tree or plant. Attached to the tree and support device is a wire or cord. For added support, additional posts are embedded into the ground and tied to the tree. In all of these devices an obstruction is left above ground level. In some cases, this obstruction is undesirable and dangerous. Therefore, a need exists for a device which can support a tree, but also provides the option of additional support via a wire or cord, which may or may not be used.

In addition, the prior art typically comprises flimsy material such as wood or wood composites used for stakes or posts. These materials are often selected for economic reasons. However, they do not provide the capability of continual use over an extended period of time. Moreover, they do not provide a needed sturdiness which can withstand high winds or other elements of nature that are applied to the trees and plants.

Another problem with prior art devices is that a growth development aid or fertilizer is not provided. Typically, young or damaged trees and plants require fertilization and watering at the root system. Most current devices do not provide a manner in which the root system of the tree or plant is fertilized and/or watered.

Still another problem with current devices is installation. Many devices are difficult to install or install ineffectively. By way of example, U.S. Pat. No. 6,065,243 to Mancini provides a staple like apparatus wherein a central cross member has two prongs joined at the cross member's opposing ends. During the planting process, one prong is hammered into the root system of the tree. Thereafter, the other prong is hammered into the ground. The problem with this type of installation is that the cross member bends due to the loads and stresses applied across the same during the hammering process. This bending greatly decreases the effectiveness of the device in that it's ability to provide a sturdy and stable structure is compromised. If, however, the device is hammered at its center, then the cross member will bend from the direct impact of the hammer.

Despite all of the prior art listed above, there is still a need in the marketplace for a multi-functional supporting device that is easy to install and that provides stability and support for trees and other plant life while also providing growth development aid. All of these needs are satisfied by the present invention.

### SUMMARY OF THE INVENTION

Briefly, the present invention satisfies the needs for a multi-functional tree support and stabilization device that maintains a desired position of a tree or plant while the same is maturing and the root system is developing. Further, the invention satisfies the need for a device that helps facilitate growth of a root system or recovery of a damaged root system by providing water or fertilizer. Therefore, the aforementioned background problems are obviated by the tree support device herein disclosed.

In one embodiment of the present invention, an elongate cross member having opposing first and second ends is provided. Near one end of the cross member there preferably is a notch, ring or the like which allows a user the option of further supporting the tree by attaching a wire or cord to the tree trunk and tying the free end off at the notch, ring or the like. Attached intermediate the ends of the horizontal cross member and preferably level with its upper end is a first stake member. The first stake member is preferably a hollow, tubular configuration and has an open inlet at its upper end for allowing water and fertilizer to be placed therein. More preferably, the first stake member is attached near the center of the cross member. A plurality of apertures extending vertically along and around the length of the first stake member also provided. The apertures allow the water and/or fertilizer to be disseminated into the ground near the root system, thereby stimulating growth of the same. At the distal end of the first stake member is preferably a tapered and pointed insertion point for ease of installation.

Attached intermediate the first stake member and the end of the cross member opposing the notch or ring is a second stake member. The second stake member is of a shorter length than the first stake member and preferably comprises a hollow, tubular configuration. Further, and as with the first stake member, preferably an inlet at the upper end and an insertion point at the distal end are provided.

Also provided is an insertion aid for uniformly embedding the device into the ground without bending or deforming the same. In the preferred embodiment of the present invention, the insertion aid includes two outwardly extending prongs which matingly engage with the open inlets of the first and second stake members. In operation, the prongs of the insertion aid are placed within the inlets of the stake members. Thereafter, the device is uniformly driven into the ground by hammering near the center of the top of the insertion aid. The second stake member is embedded into the root system of a tree or plant for support and stability and the first stake member is driven into solid ground a small distance from the root system. As water and/or fertilizer is placed in the open inlet of the first stake member, it is disseminated into the ground by the root system, thereby stimulating growth. If additional support is desired a wire or cord or the like can be secured to the tree or plant and tied to the notch or ring of the cross member.

In an alternative embodiment of the present invention, a curved cross member is provided which may have a large radius of curvature concave to the ground. Attached at the approximate center of the cross member is a stake member. The attachment of the stake member is configured so that a small portion of the upper end of the stake projects upwardly from the cross member. This projection allows the device to be uniformly driven into the ground during operation. After being driven into the ground, the ends of the cross member engage the ground.

The stake member is preferably of a hollow, tubular configuration and has an open inlet at its upper end for allowing water and fertilizer to be placed therein. Further, the preferred stake member is provided with a plurality of apertures extending vertically along and around the length of the member. The apertures allow the water and/or fertilizer to be disseminated into the ground near the root system, thereby stimulating growth. At the distal end of the stake member is preferably an insertion point for ease of installation.

Attached near one end of the horizontal cross member is a notch, ring or the like for additional support, if desired. The user may simply tie a wire or cord or the like around the tree and tie the remaining free end to the notch or ring before, during or after driving the device into the ground.

It is therefore a principal object of the present invention to provide a multi-functional apparatus for supporting and stabilizing young or damaged trees and plants.

It is another object of the present invention to provide a multi-functional device which aids in the growth and development of root systems of the trees and plants being supported by providing means for disseminating water and/or fertilizer.

It is another object of the present invention to provide a multi-functional supporting device which allows the user the option of adding additional support by tying a wire or cord to the tree or plant and securing the same to the device.

It is another object of the present invention to provide a multi-functional support system that may be removed and reused after the tree or plant has matured or recovered.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings in which:

FIG. 1 is an isometric view of a preferred embodiment of the tree supporting device;

FIG. 2 is a pictorial diagram of the invented tree support device of FIG. 1 shown in use with a tree;

FIG. 3 is a isometric view of an alternative embodiment of the invented tree supporting device; and

FIG. 4 is a pictorial diagram of the alternative embodiment of FIG. 3 shown in use with a tree.

It is to be understood that the drawings are merely illustrative of the invention and are not meant to limit the claims. Various modifications and additions may be made to the apparatus by those skilled in the art, without departing from the spirit and scope of this invention, which is therefore understood to be limited only by the scope of the appended claims.

### DETAILED DESCRIPTION OF THE PREFERRED EMBODIMENTS

As required, detailed embodiments of the present invention are disclosed herein, however, it is to be understood that the disclosed embodiments are merely exemplary of the invention, which may be embodied in various forms. Therefore, specific structural and functional details disclosed herein are not to be interpreted as limiting.

The present invention is useful with any metal, plastic or combination thereof. Suitable metals are iron, stainless steel, aluminum, copper, or the like. Suitable plastics are recycled plastics, injection molded plastics, reinforced plastics or the like.

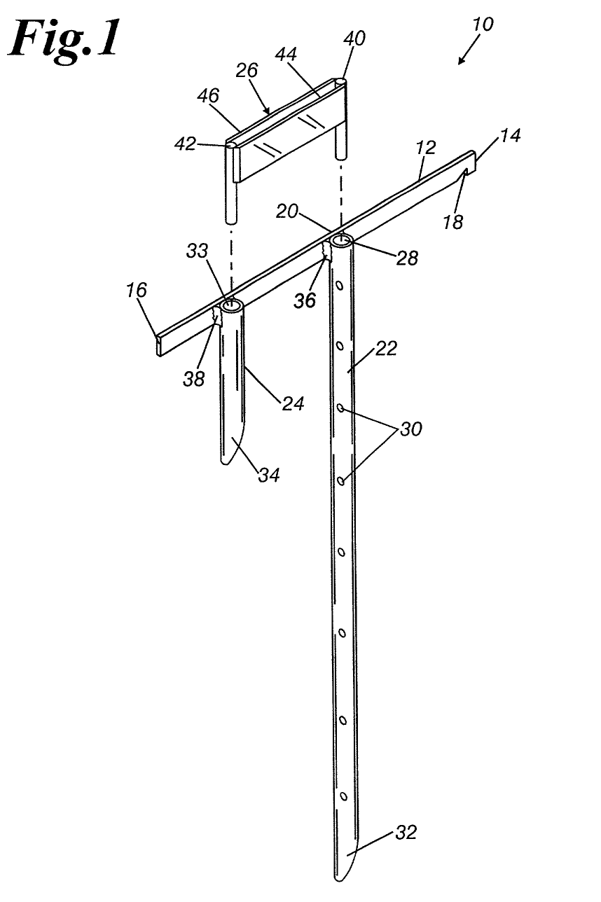

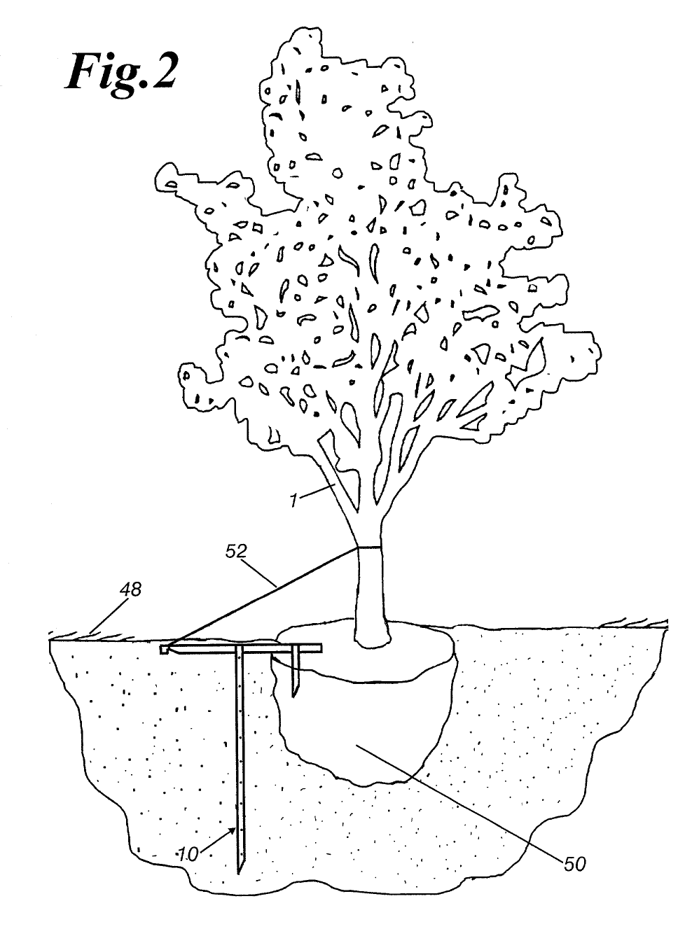

Referring now to the drawings, and particularly to FIGS. 1 and 2, a preferred embodiment of the invented tree support device 10 is shown. The tree support device 10 generally comprises an elongate cross member 12 of a generally rectangular cross section (although other cross sectional shapes may be employed) having a first end 14 and a second end 16. Located near the first end 14 is a notch or ring 18 for securing one end of a wire or cord 52. A first downwardly and perpendicularly extending stake member 22 is attached intermediate the first and second ends, 14 and 16, of the cross member 12, or integrally formed therewith. In a preferred embodiment, the first stake member 22 is attached at the approximate center 20 of the cross member 12. The preferred manner of attachment of the first stake member 22 is a weld 36.

A second downwardly, perpendicular extending stake member 24 is attached, or integrally formed, intermediate the first stake member 22 and the second end 16 of the horizontal cross member 12. Again, the preferred manner of attachment of the stake member is a second weld 38. A ground insertion aid 26 is provided which is removably and matingly engageable with the first and second stake members, 22 and 24 respectively.

Referring to FIG. 1, the first stake member 22 is preferably of a hollow, tubular configuration and has an open inlet 28 at its upper end. It will be understood by those skilled in the art that the stake member 22 may be of a solid configuration. Still further, the first stake member 22 has a circular cross section, however, it will be appreciated by those skilled in the art that alternative cross sections can be employed such as a rectangular cross section. The inlet 28 provides access to the interior of the hollow stake member 22 so that water and/or fertilizer is disposed therein and may consequently exit from a plurality of apertures 30 extending vertically along and around the length of the member22. The consequent deposit of food and water provides a growth stimulus. Further, at the lower end of the first stake member 22 is preferably an insertion point 32 for ease of installation. The insertion point 32 of the stake 22 is tapered and pointed. The tapered insertion point 32 of the stake member 22 is adapted so that installation into the ground 48 is relatively easy.

Attached intermediate the first stake member 22 and the second end 16 is a second stake member 24. The second stake member 24 is of a shorter length than the first stake member 22 and preferably comprises a hollow tubular configuration. Further, and as with the first stake member 22, an inlet 33 at the upper end and an insertion point 34 at the distal end is preferably provided.

Attachment of the stake members, 22 and 24, is preferably configured so that the same is substantially flush with the flat upper surface of the cross member 12. However, it will be understood by those skilled in the art that the stake members, 22 and 24, may be attached so that the same projects outwardly from the cross member 12. In this optional configuration, the cross member 12 can be buried in the ground so that only the projections of the stake members 22 and 24 are above the ground.

FIG. 2 of the drawings show a young plant or tree 1 growing from the ground 48. The tree 1 has the root ball or system shown generally as 50 beneath the ground surface 48. The support device 10 is shown having its stake members, 22 and 24 respectively, driven into the ground 48 and root ball 50 until the cross member 12 is flush with the ground surface 48. The lower portions, 32 and 34, of the stake members, 22 and 24, are shown in detail in FIG. 1.

The notch 18 further operates to secure the tree or plant 1 in place. In operation, the wire or cord 52 is tied to the notch 18 and thereafter tied to the trunk of the tree or stem of the plant 1 for additional support.

The insertion aid 26 for embedding the device 10 into the ground 48 generally comprises a pair of generally rectangular, flat plates 44 and 46, welded together with a pair of prongs 40 and 42. The prongs 40 and 42, are of a solid circular configuration and have a diameter less than the diameter of the inlets, 28 and 33. Of course, if the inlets 28 and 33 are non-circular in shape, the prongs 40 and 42 are the same non-circular shape. In operation, the prongs 40, 42, of the insertion aid 26 are placed within the inlets 28, 33, of the stake members 22, 24. Thereafter, the device 10 is uniformly driven into the ground 48 by hammering near the center of the insertion aid 26 on plates 44,46. The second stake member 24 is embedded into the root system 50 of the tree 1 for support and stability and the first stake member 22 is driven into firm ground a small distance from the root system 50. As water and/or fertilizer is placed in the open inlet 28 of the first stake member 22, it is disseminated into the ground 48 by the root system 50, thereby stimulating growth.

Alternatively, it will be understood by those skilled in the art that the insertion aid 26 will generally comprise a pair of plates fixed together by a pair of hollow prongs if the stake members, 22 and 24, are of a solid configuration. In operation, the hollow prongs would fit over the upper ends of the stake members, 22 and 24, prior to embedding the device 10 into the ground 48.

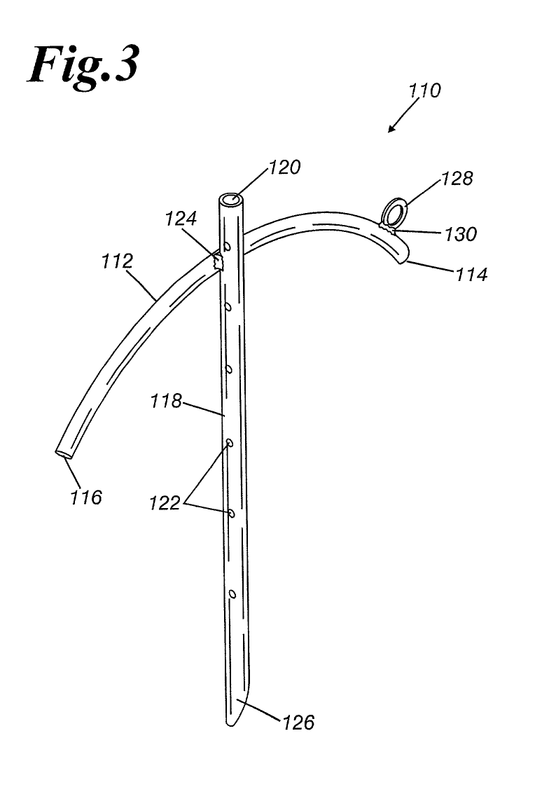

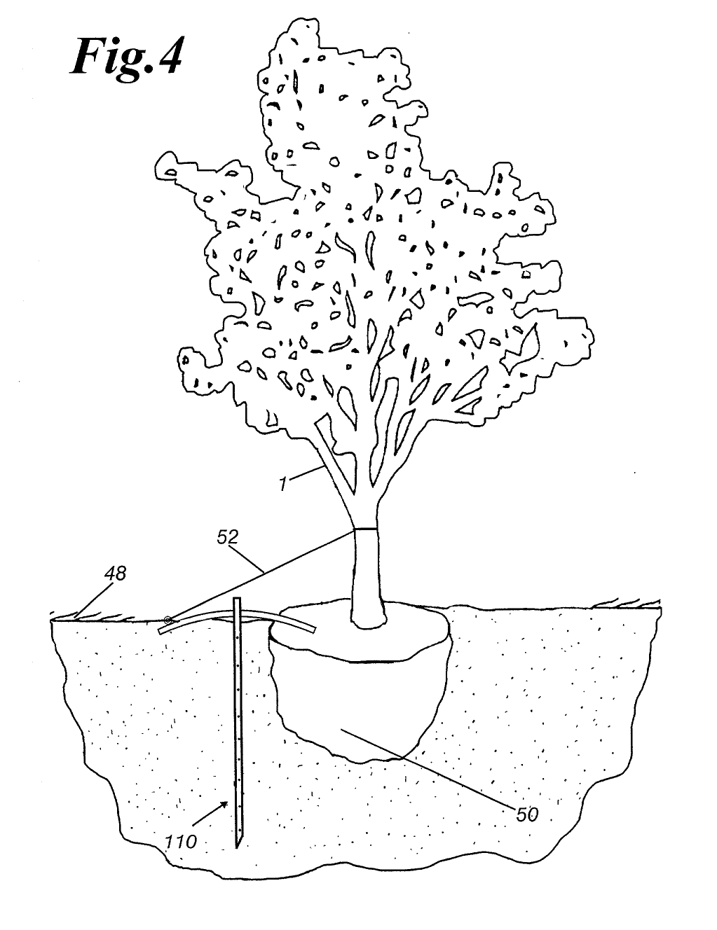

An alternative embodiment of the present invention is shown in FIGS. 3 and 4. In the alternative embodiment, a curved cross member 112 having opposing first and seconds ends, 114, 116 is provided which preferably has a large radius of curvature concave to the ground 48. Attached at the approximate center of the bight of the cross member 112 is a stake member 118. The stake member 118 is attached to the cross member 112 at a weld 124 and is configured so that a small portion of the upper of the stake 118 projects upwardly from the cross member 112. This manner of attachment allows the device 110 to be uniformly driven into the ground 48 during operation.

The stake member 118 is preferably of a hollow, tubular configuration and has an open inlet 120 at its upper end for allowing water and fertilizer to be placed therein. Further, the stake member 118 is provided with a plurality of apertures 122 extending vertically along and around the length of the member 118. The apertures 122 allow the water and/or fertilizer to be disseminated into the ground 48 near the root system 50, thereby stimulating growth of the same. At the distal end of the stake member 118 is preferably an insertion point 126 for ease of installation. Again, the insertion point 126 of the stake 118 is tapered and pointed.

Attached at one end of the cross member 112 is a securing means 128 such as a notch or ring for additional support, if desired. The securing means 128 is preferably attached to the cross member 112 by a weld 130. The user may simply tie a wire or cord 52 around the tree 1 and tie the remaining free end to the ring 128 before driving the device into the ground 48.

As shown in FIG. 4, the end of the cross member 112 having the notch or ring 128 is positioned away from the tree, while the opposing end contacts and secures the root ball 50, when the device 110 is firmly in position.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A tree support device, comprising:
an elongate cross member having opposing first and second ends, said first end having a securing means located thereon;
a first stake member extending perpendicularly from said cross member, said first stake member having a plurality of apertures extending along and around its length and being connected intermediate said first and second ends; and
a second stake member extending perpendicularly from said cross member, said second stake member being connected intermediate the second end and the first stake.

2. The support device according to claim 1, wherein said stake members have a hollow, tubular configuration and comprise an upper end having an open inlet and a distal end.

3. The support device according to claim 1, wherein said first stake member is of greater length than said second stake member.

4. The support device according to claim 1, wherein said first and second stake members are attached to said cross member by a weld.

5. The support device according to claim 2, wherein said device further includes a removable installation aid which is matingly engageable with said open inlets of said stake members, said installation aid being adapted to allow uniform penetration into a ground area.

6. The support device according to claim 2, wherein said stake members distal ends are tapered.

7. The support device according to claim 1, wherein the securing means comprises a notch or ring.

8. The support device according to claim 2, wherein said upper ends of said stake members are substantially flush with said cross member.

9. The support device according to claim 2, wherein said upper ends of said stake members project above said cross member.

10. The support device according to claim 9, wherein said device further includes a removable installation aid which is matingly engageable with said projecting upper ends of said stake members, said installation aid being adapted to allow uniform penetration into a ground area.

11. A tree support device, comprising:
an concave cross member having opposing first and second ends, said first end having a securing means located thereon;
a stake member extending perpendicularly from the bight of said cross member, said stake member having a plurality of apertures extending along its length and being connected to the approximate center of said cross member; and
wherein said stake member comprises a hollow, tubular configuration and includes an upper end having an open inlet and a distal end.

12. The support device according to claim 11, wherein said stake member is attached to said cross member by a weld.

13. The support device according to claim 11, wherein said stake member's lower end is tapered.

14. The support device according to claim 11, wherein said securing means comprises a notch or ring.

15. The support device according to claim 11, wherein said upper end of said stake member is substantially flush with said cross member.

16. The support device according to claim 11, wherein said upper end of said stake member projects above said cross member.
